(19) United States
(12) Patent Application Publication
(10) Pub. No.: US 2007/0064432 A1
(43) Pub. Date: Mar. 22, 2007

(54) Light-source lamp

(75) Inventor: Yoshio Kubo, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/392,886

(22) Filed: Mar. 30, 2006

(30) Foreign Application Priority Data
Sep. 16, 2005 (JP) 2005-270892

(51) Int. Cl. F21V 7/00

(52) U.S. Cl. 362/341

(57) ABSTRACT

According to one embodiment, a light-source lamp is provided with a reflector, a light-emission tube, a support member and a heat radiation member. The reflector includes a cylindrical portion located in the center thereof. The light-emission tube includes a base located at one end. The base extends through the cylindrical portion of the reflector, with a predetermined distance maintained with respect to the inner surface of the cylindrical portion, and is projected behind the reflector. The support member couples the light-emission tube and the reflector together and includes a side portion having an air discharge hole formed at a predetermined position thereof. The heat radiation member is attached to the base of the light-emission tube and covers the air discharge hole of the support member. The heat radiation member has holes smaller than the air discharge hole.

### CROSS-REFERENCE TO RELATED APPLICATIONS

This application is based upon and claims the benefit of priority from prior Japanese Patent Application No. 2005-270892, filed Sep. 16, 2005, the entire contents of which are incorporated herein by reference.

### BACKGROUND

1. Field

One embodiment of the invention relates to a light-source lamp for use in a color projector, especially in a color projector of a digital light processing (DLP) type.

2. Description of the Related Art

As is well known, a color projector of a DLP type passes the white light from a light-source lamp through the red (R), green (G) and blue (B) segments of a rotating color wheel and guides the resultant light beams to the panel surface of a digital micro mirror device (DMD).

In synchronism with the light beams that are transmitted from the R, G and B segments on a time divisional basis, the panel surface of the DMD forms optical images corresponding to the R, G and B beams. The optical images are formed by the reflection by a large number of micro mirrors. The R, G and B optical images the DMD forms are enlarged by a projection lens and are then projected onto a screen. In this manner, a color image is displayed.

The light-emission tube of the light-source lamp described above becomes as hot as 200 to 1,200° C. when it emits light. A reflector, which covers the light-emission tube, also becomes hot. It is therefore necessary to provide a cooling means.

Jpn. Pat. Appln. KOKAI Publication No. 2003-29342 discloses a structure wherein a light-shielding plate is provided behind a reflector to shield leaking light, and air is made to flow through the region defined by the reflector and the light-shielding plate, for cooling.

Jpn. Pat. Appln. KOKAI Publication No. 2004-241258 discloses a structure wherein air is taken in from the region in front of a reflector and is discharged into the region behind a reflector by way of an air outlet port. The structure disclosed in KOKAI Publication No. 2004-241258 may enable the reflector and the light source to be cooled at a time.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 illustrates the outline of a DPL type color projector according to a first embodiment;

FIG. 2 is a sectional side view showing an example of a light-source lamp which is employed in the DLP type color projector according to the first embodiment;

FIG. 3 is an exploded perspective view showing how the light-source lamp according to the first embodiment looks like when it is viewed from behind;

FIG. 4 is an expansion plan of an example of a heat radiation member employed in the light-source lamp according to the first embodiment;

FIG. 5 is an expansion plan of another example of the heat radiation member according to the first embodiment;

FIG. 6 is an expansion plan of still another example of the heat radiation member according to the first embodiment;

FIG. 7 is an expansion plan of a further example of the heat radiation member according to the first embodiment;

FIG. 8 is an expansion plan of a still further example of the heat radiation member according to the first embodiment;

FIG. 9 is an expansion plan of another conceivable example of the heat radiation member according to the first embodiment; and

FIG. 10 is an expansion plan of still another conceivable example of the heat radiation member according to the first embodiment.

### DETAILED DESCRIPTION

Various embodiments according to the invention will be described hereinafter with reference to the accompanying drawings. In general, according to one embodiment of the invention, a light-source lamp is provided with a reflector, a light-emission tube, a support member and a heat radiation member. The reflector includes a cylindrical portion located in the center thereof. The light-emission tube includes a base located at one end. The base extends through the cylindrical portion of the reflector, with a predetermined distance maintained with respect to the inner surface of the cylindrical portion, and is projected behind the reflector. The support member couples the light-emission tube and the reflector together and includes a side portion having an air discharge hole formed at a predetermined position thereof. The heat radiation member is attached to the base of the light-emission tube and covers the air discharge hole of the support member. The heat radiation member has holes smaller than the air discharge hole.

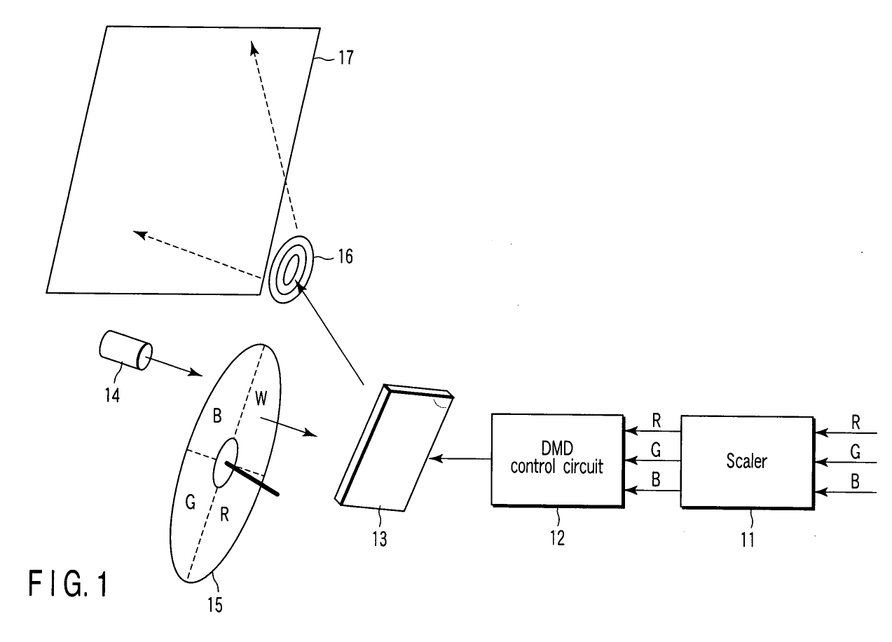

An embodiment of the present invention will now be described with reference to the accompanying drawings. FIG. 1 shows illustrates the outline of a DPL type color projector, which is an embodiment of the present invention. Referring to FIG. 1, reference numeral 11 denotes a scaler. The scaler 11 receives digital R, G and B signals and generates R, G and B pixel signals. The R, G and B pixel signals correspond to the resolution (the number of pixels) of a DMD panel 13 connected to the output side of the scaler 11. The scaler 11 adjusts the number of pixels of the R, G and B signals it receives, in such a manner that the adjusted number of pixels corresponds to the micro mirrors (the number of pixels) of the DMD panel 13.

The R, G and B pixel signals output from the scaler 11 are supplied to a DMD control circuit 12. The DMD control circuit 12 generates a white (W) pixel signal on the basis of the R, G and B pixel signals, and supplies this white (W) pixel signal and the R, G and B pixel signals to the DMD penal 13 on a time divisional basis.

The white light emitted from a light-source lamp 14 passes through a rotating color wheel 15 and then falls on the micro mirror array surface of the DMD panel 13. The color wheel 15 comprises four segments corresponding to R, G, B and W. When the color wheel 15 is rotated, the white light from the light-source lamp 14 sequentially passes through the segments and then falls on the micro mirror array surface of the DMD panel 13.

In accordance with the R, G, B and W pixel signals supplied, the DMD panel 13 switches the reflecting directions of the micro mirror pixels on a time divisional basis. The DMD panel 13 reflects the light that is incident thereon after passing through the color wheel 15, in such a manner that the reflected light (which is colored image light) travels toward a lens 16. The times when the micro mirrors of the DMD panel 13 are driven in accordance with the R, G, B and W pixel signals are controlled so that they are synchronous with the times when the light beams passing through the R, G, B and W segments of the color wheel 15 are incident on the DMD panel 13.

An enlarged color image output from the lens 16 is projected onto a screen 17. In this manner, the image is displayed.

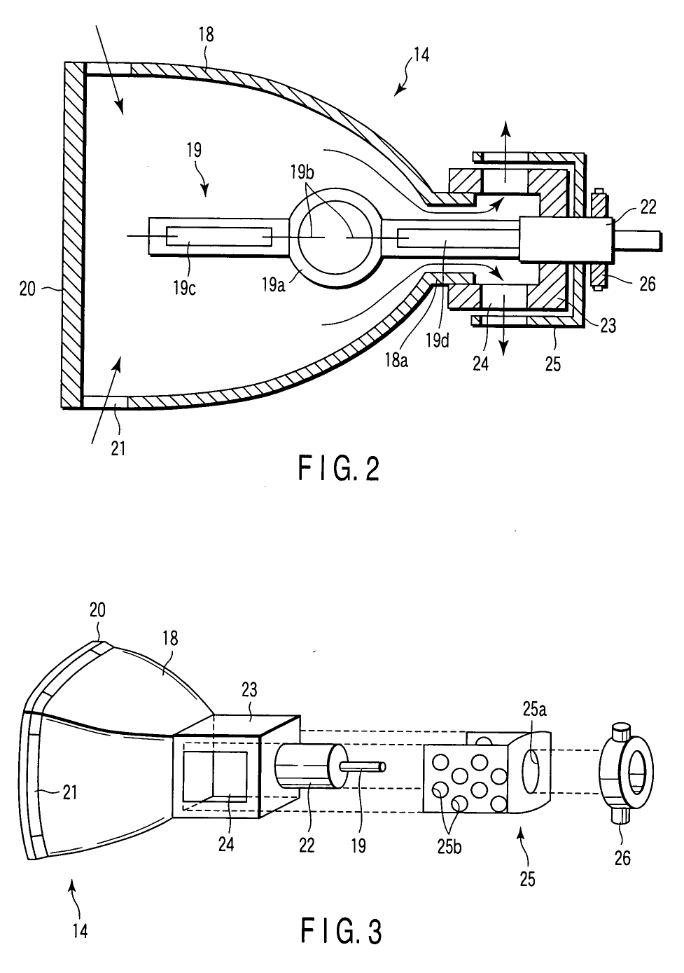

FIG. 2 shows the structure of the light-source lamp 14 described above. As shown in FIG. 2, the light-source lamp 14 comprises a reflector 18 having a substantially-hemispherical concave light reflecting surface. The light-source lamp 14 also comprises a light-emission tube 19 located in the center of the reflector 18.

The light-emission tube 19 includes a spherical member 19a, a pair of electrodes 19b, a front sealed portion 19c and a rear sealed portion 19d. Mercury vapor is sealed in the spherical member 19a at a low pressure of one atmosphere or less. The front sealed portion 19c having one of the electrodes 19b is coupled to the front portion of the spherical member 19a, and the rear sealed portion 19d having the other one of the electrodes 19b is coupled to the rear portion of the spherical member 19a. Inside the spherical member 19a, the electrodes 19b have their tip ends opposed to each other, with a predetermined distance maintained. The spherical member 19a emits light when electrical discharge occurs between the electrodes 19a.

The visible light emitted from the light-emission tube 19 is reflected by the reflector 18, and the reflected light converges at a point in front of the open section of the reflector 18. A front glass member 20 made of an optical transparent material is provided for the front portion of the reflector 18. If the light-emission tube 19 breaks, the front glass ember 20 prevents broken pieces of structural elements from scattering. The front glass member 20 is provided in such a manner that an air inlet port 21 is defined between the front glass member 20 and the reflector 18.

The reflector 18 has a cylindrical portion 18a formed in the center thereof, and the rear sealed portion 19d of the light-emission tube 19 is inserted into this cylindrical portion 18a, with a certain distance maintained relative to the inner surface of the cylindrical portion 18a. The rear sealed portion 19d has a projection protruding rearward from the reflector 18, and a base 22 is fitted on this projection.

A cylindrical support member 23 is in engagement with the base 22. To be more specific, the support member 23 is open at one end and is closed at the other end (the closed portion of the support member 23 will be referred to as a “bottom”). The support member 23 has a hole formed in its bottom, and the base 22 is fitted in this hole. At the open end, the support member 23 is fitted around the cylindrical portion 18a of the reflector 18, thereby coupling the light-emission tube 19 and the reflector 18 together.

The support member 23 has an air discharge hole 24 formed in the side portion. The air flowing in through the air inlet port 21 passes through the region between the rear sealed portion 19d and the cylindrical portion 18a of the reflector 18, and is guided outward from the air discharge hole 24 of the support member 23. With the air flowing along this cooling passage, the reflector 18 and the light-emission tube 19 are cooled with high efficiency.

As shown in FIG. 3, a heat radiation member 25 is attached to the base 22. The heat radiation member 25 is formed by bending a metal plate in the shape of “U”. The metal plate is made of a material having a high heat radiation characteristic. The heat radiation member 25 has an attachment hole 25a formed in the center thereof, and the base 22 is inserted into this hole 25a. A nut 26 is screwed to the base 22, thereby securing the heat radiation member 25.

The heating radiation member 25 has portions facing the air discharge hole 24 of the support member 23. The heat radiation member 25 has a plurality of holes 25b formed in such portions. The holes 25b are smaller than the air discharge hole 24 but are large enough to ensure heat-radiating air streams.

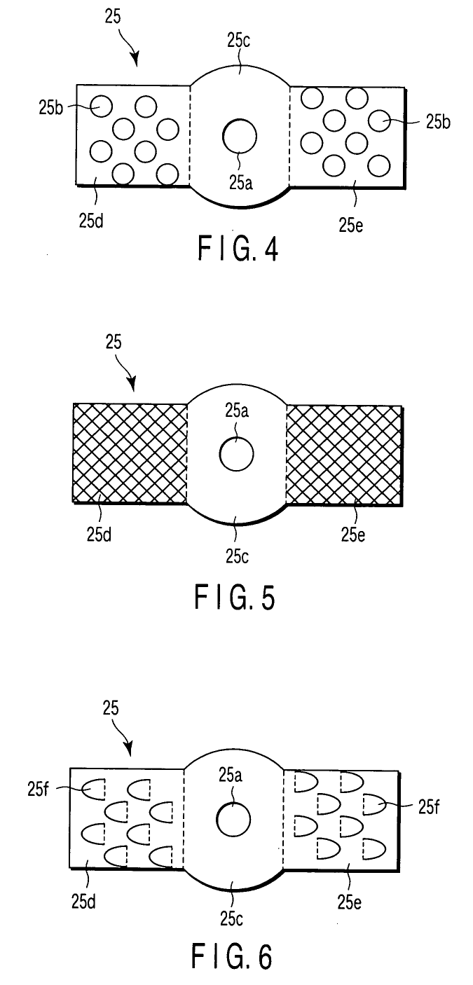

FIG. 4 shows the heat radiation member 25 in the expanded state. The heat radiation member 25 is a metal plate having high thermal conductivity and including a center portion 25c and heat radiation pieces 25d and 25e. The center portion 25c is opposed to the bottom surface of the support member 23. The heat radiation pieces 25d and 25e are extended from the center portion 25c in opposite directions. The center portion 25c has a hole 25a into which the base 22 can be inserted.

Each of the heat radiation pieces 25d and 25e has a plurality of holes 25b, and, as described above, these holes are smaller than the air discharge hole 24 but are large enough to ensure heat-radiating air streams. The heat radiation pieces 25d and 25e are bent relative to the center portion 25c in such a manner that the heat radiation pieces 25d and 25e face each other. In this manner, the heat radiation member 25 is formed.

In the embodiment described above, an air stream passage is defined by the air inlet port 21, the space between the rear sealed portion 19d and the cylindrical portion 18a of the reflector 18, the air discharge hole 24 of the support member 23, and the holes 25b of the heat radiation member 25. Owing to the air flowing through the air stream passage, the heat of the light-emission tube 19 and the reflector 18 is radiated.

The heat generated by the base 22 is radiated from the heat radiation member 25. Since the heat radiation member 25 is cooled by the air flowing out from the air discharge hole 24, a sufficient cooling effect can be expected.

The air discharge hole 24 of the support member 23 is covered with the heat radiation pieces 25d and 25e each having a plurality of holes 25b that are smaller than the air discharge hole 24. With this structure, even if the light-emission tube 19 breaks, the broken pieces of the light-emission tube 19 do not scatter. This advantage is very useful in practice. In addition, the heat radiation pieces 25d and 25e are effective in shielding the light leaking from the air discharge hole 24.

FIG. 4 depicts the holes 25b of the heat radiation member 25 as being circular, but the holes 25b are not limited not only in shape but also in number. In addition, heat radiation pieces 25d and 25e of the mesh structure may be employed in place of the heat radiation pieces 25d and 25e having a plurality of holes 25b, as shown in FIG. 5, and the same advantages as described above can be obtained in this case as well. That is to say, the heat radiation pieces 25d and 25e may be of any structure as long as the air discharge hole 24 are covered in such a manner that the space through which the air from the air discharge hole 24 flows is narrower or smaller than the air discharge hole 24.

FIGS. 6 through 10 show modifications of the heat radiation member 25 described above. Referring first to FIG. 6, the heat radiation pieces 25d and 25e are provided with a plurality of raised portions 25f, each of which is shaped like a tongue. The raised portions 25f define air holes. In the state where the heat radiation pieces 25d and 25e cover the air discharge hole 24 of the support member 23, the air holes defined by the raised portions 25 are opposed to the region rearward of the reflector 18. With this structure, the air flowing out of the air discharge hole 24 of the support member 23 can be guided in a direction away from the reflector 18, further improving the heat radiation effect. In addition, the raised portions 25f are also useful in preventing broken pieces from scattering.

FIG. 6 depicts the raised portions 25f as being semicircular, but the raised portions 25f are not limited not only in shape but also in number.

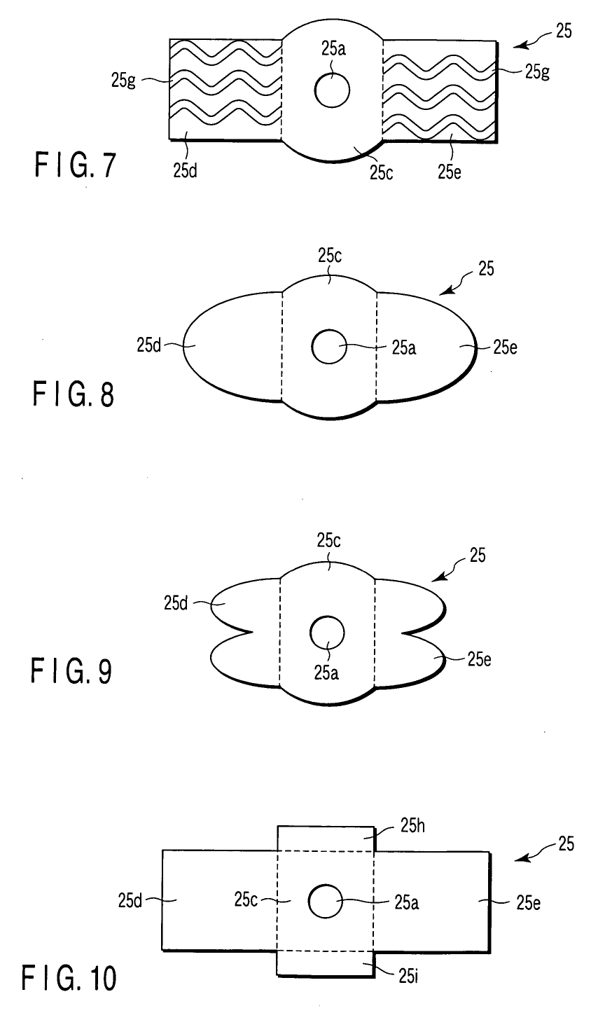

FIG. 7 shows that the heat radiation pieces 25d and 25e are provided with undulated slits 25g. FIG. 7 shows the slits 25g as being undulated, but the slits 25g is not limited not only in shape but also in number.

FIG. 8 shows that the heat radiation pieces 25d and 25e have U-shaped tip ends. With this structure, the air discharge hole 24 is not entirely covered, and the heat radiation effect is not affected. FIG. 9 shows that the heat radiation pieces 25d and 25e have end portions each having two U-shaped tips.

FIG. 10 shows that the center portion 25c of the heat radiation member 25 has fixing pieces 25h and 25i on those sides on which the heat radiating pieces 25d and 25e are not provided. The heat radiation pieces 25d and 25e and the fixing pieces 25h and 25i are bent 90° in the same direction relative to the center portion 25c. With this structure, the support member 23 is clamped by the heat radiation pieces 25d and 25e and the fixing pieces 25h and 25i, and the heat radiation member 25 can be reliably secured to the support member 23.

Since the reflector 18 is heated by the heat the light-emission tube 19 generates, a lamp shade (not shown) may be provided around the reflector 18 to facilitate the radiation of the heat from the reflector 18. Preferably, the lamp shade is formed of copper, aluminium, or another material having high thermal conductivity.

The present invention is not limited to the above embodiment or its modifications; it can be embodied or modified in various manners without departing from the spirit and scope of the invention. It should be also noted that the structural elements of the embodiment can be properly combined to create new inventions. For example, some of the structural elements may be deleted from the embodiment described above. Furthermore, structural elements of different embodiments can be properly combined.

What is claimed is:

1. A light-source lamp comprising:
a reflector including a substantially-hemispherical concave light reflecting surface and a cylindrical portion located in the center of the reflector;
a light-emission tube located in the center of the reflector, the light-emission tube including a base located at one end, the base extending through the cylindrical portion of the reflector, with a predetermined distance maintained with respect to an inner surface of the cylindrical portion, and being projected behind the reflector;
a support member configured to couple the light-emission tube and the reflector together and including (i) a bottom portion attached to the base of the light-emission tube, and (ii) a side portion attached to the cylindrical portion of the reflector and having an air discharge hole formed at a predetermined position; and
a heat radiation member attached to the base of the light-emission tube and covering the air discharge hole of the support member such that air discharged from the air discharge hole is guided outward after passing through a space narrower than the air discharge hole.

2. The light-source lamp according to claim 1, wherein the heat radiation member includes (i) a center portion having a hole which is fitted around the base of the light-emission tube, and (ii) a heat radiation piece covering the air discharge hole such that the air discharged from the air discharge hole is guided outward after passing through the space narrower than the air discharge hole.

3. The light-source lamp according to claim 2, wherein the heat radiation piece is bent relative to the center portion and covers the air discharge hole of the support member.

4. The light-source lamp according to claim 2, wherein the heat radiation piece has a plurality of holes that are smaller than the air discharge hole of the support member.

5. The light-source lamp according to claim 2, wherein the heat radiation piece includes a mesh-structure portion at a position corresponding to the air discharge hole of the support member.

6. The light-source lamp according to claim 2, wherein the heat radiation piece includes a plurality of raised portions each defining an air hole, the raised portions being smaller than the air discharge hole of the support member.

7. The light-source lamp according to clam 6, wherein the raised portions are formed such that air from the air discharge hole of the support member is guided to a region behind the reflector.

8. The light-source lamp according to claim 2, wherein the heat radiation piece includes a plurality of slits.

9. The light-source lamp according to claim 2, wherein the heat radiation piece is smaller than the air discharge hole of the support member.

10. The light-source lamp according to claim 2, further comprising a pair of fixing pieces integral with the center portion, the fixing pieces being bent relative to the center portion and sandwiching the support member.

11. A video projection apparatus comprising:
a light-source lamp provided with: a reflector including a substantially-hemispherical concave light reflecting surface and a cylindrical portion located in the center of the reflector; a light-emission tube located in the center of the reflector, the light-emission tube including a base located at one end, the base extending through the cylindrical portion of the reflector, with a predetermined distance maintained with respect to an inner surface of the cylindrical portion, and being projected behind the reflector; a support member configured to couple the light-emission tube and the reflector together and including (i) a bottom portion attached to the base of the light-emission tube, and (ii) a side portion attached to the cylindrical portion of the reflector and having an air discharge hole formed at a predetermined position; and a heat radiation member attached to the base of the light-emission tube and covering the air discharge hole of the support member such that air discharged from the air discharge hole is guided outward after passing through a space narrower than the air discharge hole;
a color wheel including a plurality of colored segments that are arranged around a rotating shaft, light emitted from the light-source lamp passing through the colored segments of the color wheel when the color wheel is being rotated;
a micro mirror device including a plurality of micro mirrors, the micro mirrors being configured to reflect light which has passed through the colored segments of the color wheel, so as to form optical images corresponding to the colored segments of the color wheel; and
a lens configured to project light which has been reflected by the micro mirror device.

12. The video projection apparatus according to claim 11, wherein the heat radiation member includes (i) a center portion having a hole which is fitted around the base of the light-emission tube, and (ii) a heat radiation piece covering the air discharge hole such that the air discharged from the air discharge hole is guided outward after passing through the space narrower than the air discharge hole.

13. The video projection apparatus according to claim 12, wherein the heat radiation piece is bent relative to the center portion and covers the air discharge hole of the support member.

14. The video projection apparatus according to claim 12, wherein the heat radiation piece has a plurality of holes that are smaller than the air discharge hole of the support member.
